(19) United States
(12) Patent Application Publication
(10) Pub. No.: US 2018/0218427 A1
(43) Pub. Date: Aug. 2, 2018

(54) RECOMMENDATION INTEGRATED ONLINE DIGITAL SALES SERVICE CHAT SYSTEM

(71) Applicant: International Business Machines Corporation, Armonk, NY (US)

(72) Inventors: Stephen Chu, Beabercreek, OH (US); Dongsheng Li, Shanghai (CN); Jinghui Li, Shanghai (CN); Xinwen Liang, Beijing (CN); Ning Sun, Beijing (CN); Yuyan Xue, Beijing (CN); Junchi Yan, Shanghai (CN)

(21) Appl. No.: 15/420,262

(22) Filed: Jan. 31, 2017

(51) Int. Cl. G06Q 30/06; H04L 12/58; H04L 29/08; G06F 17/27

(52) U.S. Cl. CPC G06Q 30/0631; H04L 51/046; G06F 17/2775; H04L 51/16; H04L 67/306

(57) ABSTRACT

An aspect of the invention relates to the field of an automatic chat support and analytics (recommender) engine for digital sales. The analytics engine interactively and iteratively collects the feature value of a client's profile by automatically generating questions in different styles and extracting the semantic information from the client's responses. The accumulated feature information for the client can enhance the capability of a recommender engine. Specifically, for item recommendation, the recommender engine includes components for item scoring and its confidence estimation, feature importance scoring, missing feature inference and confidence estimation by smoothing the corresponding feature values from the most similar clients. The recommender engine also involves a client response analytics component, which performs a quality check by evaluating the consistency between the inferred feature value from the similar clients and the extracted one from the client's response.

### BACKGROUND

Aspects of the invention relate to the field of an automatic chat support and analytics engine for digital sales and particular aspects relate to a system, method and computer program product for an automatic chat support analytics engine for engaging online clients (users) for digital sales.

In online digital sales service, human agents are few but clients are many. Moreover, human agents are often engaged with other staff One response has been the emergence of chat robot technology in areas such as personal assistants, social networks, or for Q & A services, but A digital sales context is significantly different from such areas.

Prior systems focus on natural language processing (NLP) techniques and information retrieval to find a semantically or technically correct answer or reference, e.g., IBM's Watson, and IBM's Cortana.

### SUMMARY

According to an embodiment of the invention, a recommendation driven online digital sales chat service system comprises: a processor; a memory, operably coupled to the processor, and storing: client profile data; historical purchase data; service and complaint data offline; and historical chat data; language corpus and materials and online chat data online; an offline client preference inference engine configured to receive the offline client profile data, the historical purchase data, the service and complaint data; an online client interest inference engine configured to receive the online historical chat data; language corpus and materials and online chat data and to generate an online client preference based on the online chatting data; an online client preference fusion and detection and client valuation module configured to generate an online client chat engagement based on the offline client preference and the online client preference.

According to an embodiment of the invention, a computer-implemented method for a recommendation driven online digital sales chat service comprises: storing client profile data; storing historical purchase data; storing service and complaint data; storing historical chatting data; receiving offline client profile data, historical purchase data, service and complaint data, and historical chatting data and providing an output; storing online chatting data; receiving online chatting data and providing an output; and receiving the outputs of the offline client preference inference engine and online interest inference engine for generating an online client chat engagement.

According to an embodiment of the invention, a computer program product: storing client profile data; storing historical purchase data; storing service and complaint data; storing historical chatting data; receiving offline client profile data, historical purchase data, service and complaint data, and historical chatting data and providing an output; storing online chatting data; receiving online chatting data and providing an output; and receiving the outputs of the offline client preference inference engine and online interest inference engine for generating an online client chat engagement.

### BRIEF DESCRIPTION OF THE DRAWINGS

Various objects, features, and advantages of the present invention will become more clear from the following description, take in conjunction with the accompanying drawings, in which:

FIG. 1 is a schematic block diagram of an embodiment of a system in accordance with the present invention.

FIG. 2 is a schematic block diagram of an embodiment of a system, including a hybrid recommender system, in accordance with the present invention.

FIG. 3 is a schematic block diagram of an embodiment of an iterative feature extraction and recommendation method in accordance with the present invention.

FIG. 4 is a schematic block diagram of an embodiment of a hybrid recommender engine in accordance with the present invention.

FIG. 5 is a block diagram of an embodiment of a client feedback analytics, filtering, and re-asking unit in accordance with the present invention.

FIG. 6 is a schematic diagram of an embodiment of a client question tuning and customization in accordance with the present invention.

FIG. 7 is an embodiment of a method in accordance with the present invention.

FIG. 8 is an embodiment of a computer system in accordance with the present invention.

### DETAILED DESCRIPTION OF PREFERRED EMBODIMENTS

Aspects of the invention relate to an automatic online chat support analytics engine (also sometimes referred to as a recommender engine) for digital sales.

By way of overview, in some embodiments, the analytics engine can interactively and iteratively identify and collect feature information/value based on a client's profile by automatically generating questions in different styles and extracting semantic information from the client's responses. Accumulated feature information can enhance the capability of a recommender engine. For example, an item recommender engine may include components for item scoring and its confidence estimation, feature importance scoring, missing feature inference and confidence estimation, by smoothing the corresponding feature information with respect to similar clients. The recommender engine can also include a client response analytics component, which performs a quality check by evaluating the consistency between one or more inferred feature values of similar clients and those extracted from a client's response. Moreover, the style of questions can be dynamically adjusted to the personal preferences of clients, e.g., according to sentiment analysis of client textual feedback and other signals such as the textual quality of the feedback.

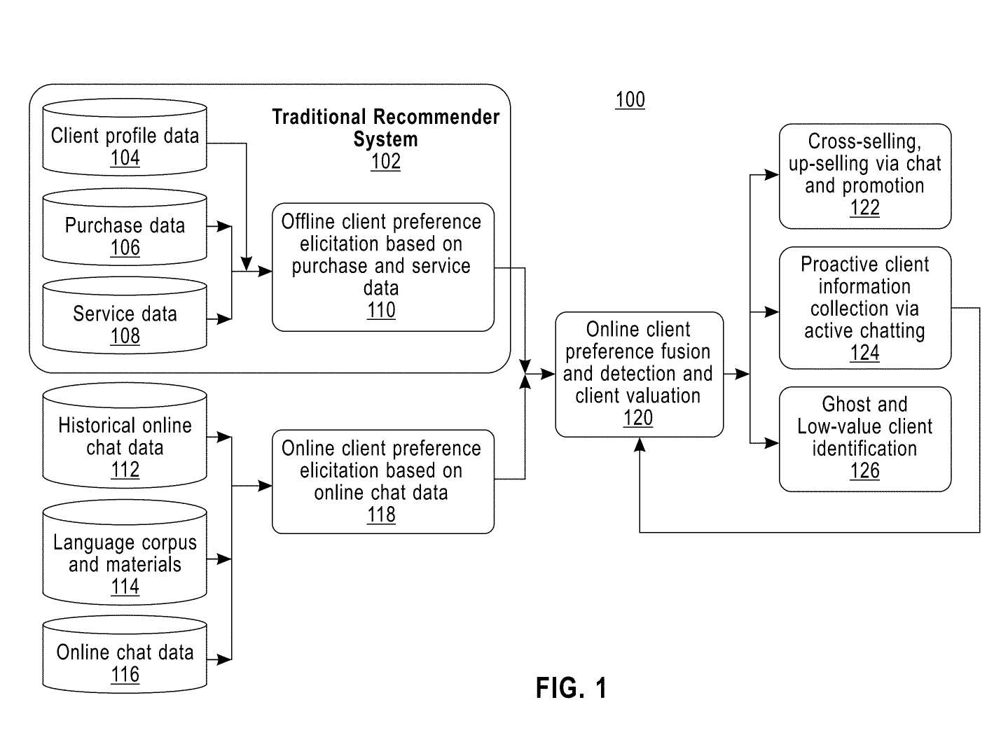

Referring now to the figures and to FIG. 1 in particular, there is shown a schematic block diagram of an embodiment of a system 100 in accordance with the present invention.

As depicted, a recommender system 102 can include storage for: client profile data 104, purchase data 106, and service data 108. The stored data 104, 106, and 108 are provided to an offline client preference elicitation based on the purchase and service data relating to the client 104.

In addition, storage for historical online chat data 112, language corpus and materials data 114, online chat data 116 may be provided. Such data (and any feedback from client information and collection unit 124, discussed below) can be provided to an online client preference elicitation unit, which can be based on online chat data 116. The outputs of offline client preference elicitation unit 110 and online client preference elicitation unit 118 are provided to an online client preference fusion and detection and client valuation module 120. The module 120 can fuse the “offline” data with the “online” data and provide the results to one or more of: a cross-selling, up-selling via chat and promotion unit 122 for recommending (cross-selling and up-selling) and promoting products: a proactive client information collection unit 124 for iteratively and actively collecting updated data (e.g., via active chat) related to the client; and a ghost and low value client identification unit 126 for identifying ghost and low value clients. The output (e.g., iterative and active interaction query↔recommendation data) from proactive client information and collection unit 124 can be fed back to the online client preference fusion module 120.

In some embodiments, the offline client preference elicitation unit 110 incorporates and uses a collaborative filtering and content+profile based recommender algorithm to estimate client's preferences (and non-preferences) based on historical: profile data 104, purchase data 106 and service data 108.

Online client preference elicitation can be inferred by unit 118 from online chat data 116 along with historical chat data 112 and language corpus and other materials 114, such as training manuals.

Based on the output of the offline client preference elicitation unit 110 and the online client preference elicitation unit 118, the client preference fusion, detection and valuation module 120 can output e.g., via an online chat one or more different responses, directed to (without limitation): cross-selling; up-selling 122; collection of client information 122 such as by requesting: client company name, location, phone number, etc.; and ghost client and low value client detection 126.

Embodiments of various components of system 100 will be described and illustrated in more detail below.

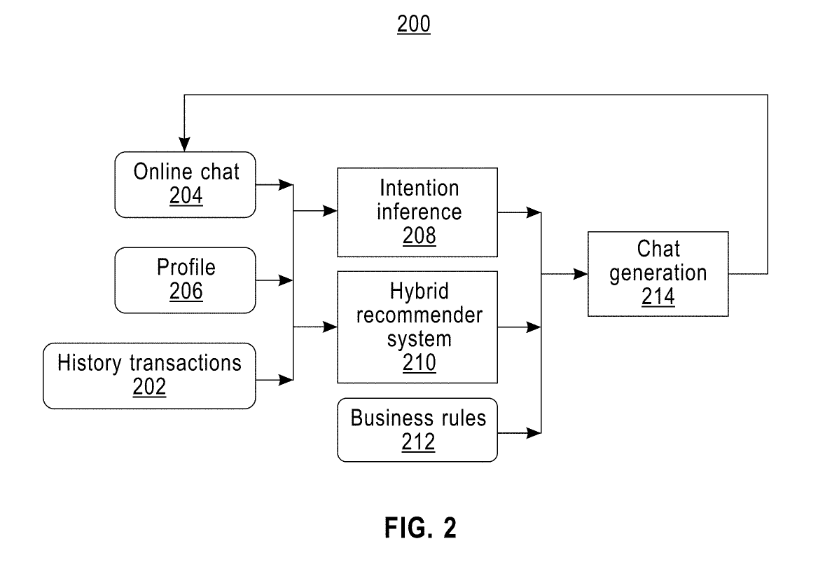

FIG. 2 is a schematic block diagram of an embodiment of a recommender engine in accordance with the invention.

A collaborative filtering and content+profile based recommender algorithm can estimate a client's preferences and non-preferences based on stored historical transaction data 202, which may include historical purchase data and service data.

A client's intentions are inferred (in real-time from on-line chat data 204 along with historical data 202 and profile materials 206, such as from a training manual. The inference 208 can be performed by using a hybrid regression model together with collaborative filtering (CF) filtering. The intention inference 208 output, hybrid recommender system 210 output and business rules 212 output are provided to chat generation unit 214. Business rules are applicable in the case where a client intends to purchase product A as inferred in accordance with an aspect of the invention and a business rule can define the response by promoting products B and C to the client.

In some embodiments, based on client profiling and preference estimation results, the chat generation unit 214 can provide varied responses, e.g., directed to one or more of: cross-selling; up-selling; active collection of client information, by asking questions about company name, location, phone number, etc., or ghost client and low value customer detection to improve the efficiency of digital service. The chat engine generation 214 output can be fed back to online chat module 204 and can be stored. Ambiguities and missing key features can also be identified by the model and the chat accordingly tuned to clarify ambiguities and/or collect missing information.

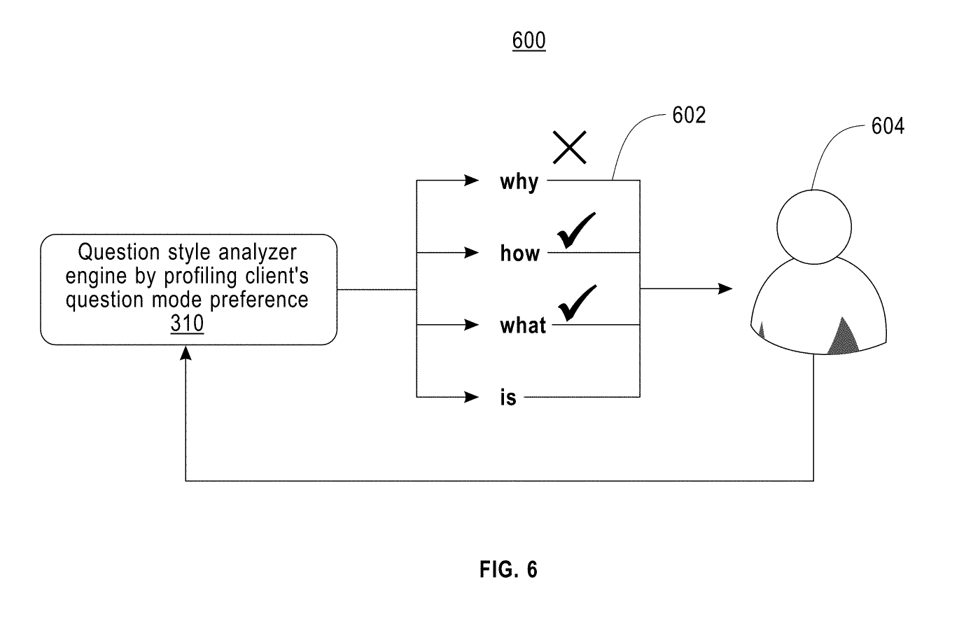

In some embodiments recommendations are generated when the chat engine is sufficiently confident and when the chat engine is less confident, additional questions are generated to further collect and update client information. In general, more accurate recommendations can be generated during multiple rounds of chat. At the same time, there may be a mechanism for automatically adjusting the question style e.g., “what is” or “how is” or “is this”, etc. (an example of which will be discussed with reference to FIG. 6), based on the chat with the client, to facilitate communication with and clarity from the clients.

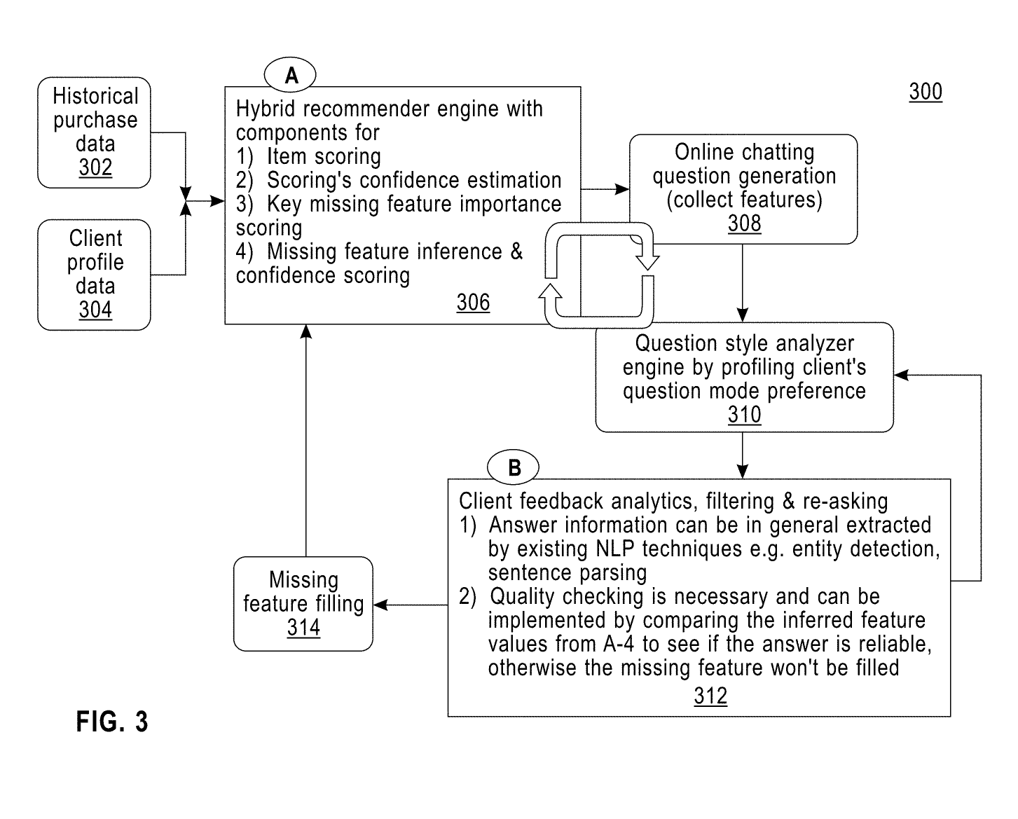

FIG. 3 is a schematic block diagram of an embodiment of an iterative feature extraction and recommendation method 300 in accordance with the present invention.

Historical purchase data from memory 302 and client profile data from memory 304 are provided to a hybrid recommender engine 306 including components for 1. Item scoring, 2. Scoring confidence estimation, 3. Key missing feature importance scoring and 4. Missing feature inference and confidence scoring.

The output from the hybrid recommender engine 306 is provided to an online chatting question generation unit 308. The output of the online chatting question generation unit is provided to a question style analyzer engine by profiling client's question mode preference unit 310. The output of the question style analyzer engine 310 is provided to client feedback analytics, filtering and re-asking unit 312. In the unit 312 answer information can be, in general, extracted by existing NLP techniques, e.g., entity detection, sentence parsing, etc. and quality checking is necessary and can be implemented by comparing the inferred feature values from the hybrid recommender, otherwise the missing feature will not be filled.

The client feedback analytics unit 312 provides feedback to the question style analyzer engine 310 to refine the form of the questions. The client feedback analytics unit 312 also provides output to a missing feature filling unit 314 which fills in missing features. The output of missing feature filling unit 314 is provided to the hybrid recommender engine 306 for incorporating the missing feature into the hybrid recommender engine output to the online chatting question generation 308.

The results of the online chatting question generation unit 308, question style analyzer engine 310, and hybrid recommender engine 306 circulate between the three units to improve the questions to a client.

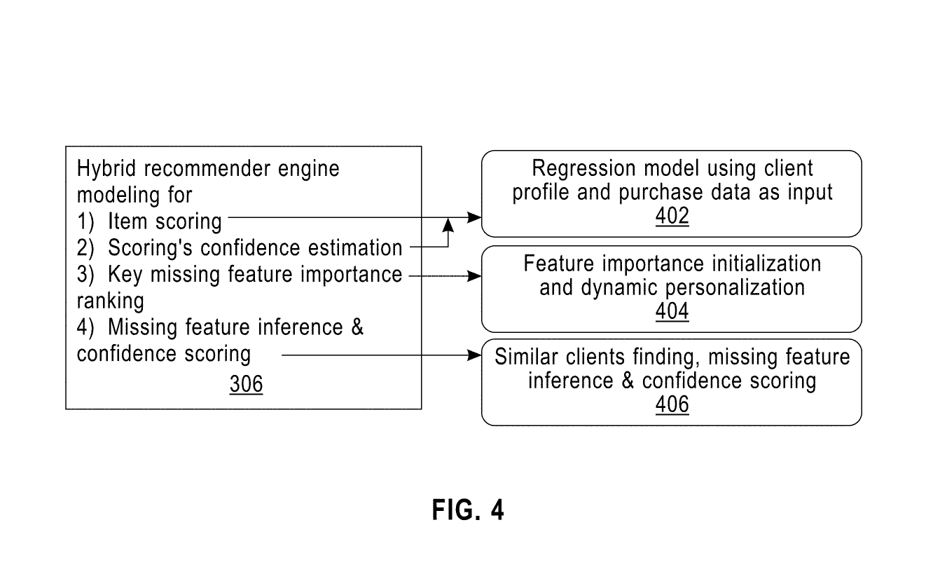

FIG. 4 is a schematic block diagram of an embodiment of a recommender engine 306 in accordance with the present invention.

The item scoring and scoring confidence estimation outputs from the hybrid recommender engine 306 are provided to a regression model 402 using client profile and purchase data as additional input. The key missing feature importance ranking from hybrid recommender engine 306 is input to feature importance initialization and dynamic personalization unit 404. The missing feature inference and confidence scoring output from hybrid recommender engine modeling engine 306 is provided to similar clients finding, missing feature inference and confidence scoring unit 406.

The feature importance initialization and dynamic personalization unit 404 can evaluate offline feature importance by removing some features and monitoring the performance response. In addition, in some embodiments, the K most similar clients can be found online for a given client, using a known profile, and then rank the remaining missing features by their completeness (match) with other K clients.

A K-nearest neighbors algorithm (K-NN) can be used to find a given client's most similar clients and use their feature values to infer the missing value and confidence by computing feature similarity. By way of example only, if K=5, a, b, c clients' feature value is 1.5, and d, e's client feature value for the test client can be computed by the mean (1.5*3+2.5*2)/5=1.9, and its confidence can be computed by the variance, where a, b, c, d, and e are different clients, i.e., the clients most similar to a given client.

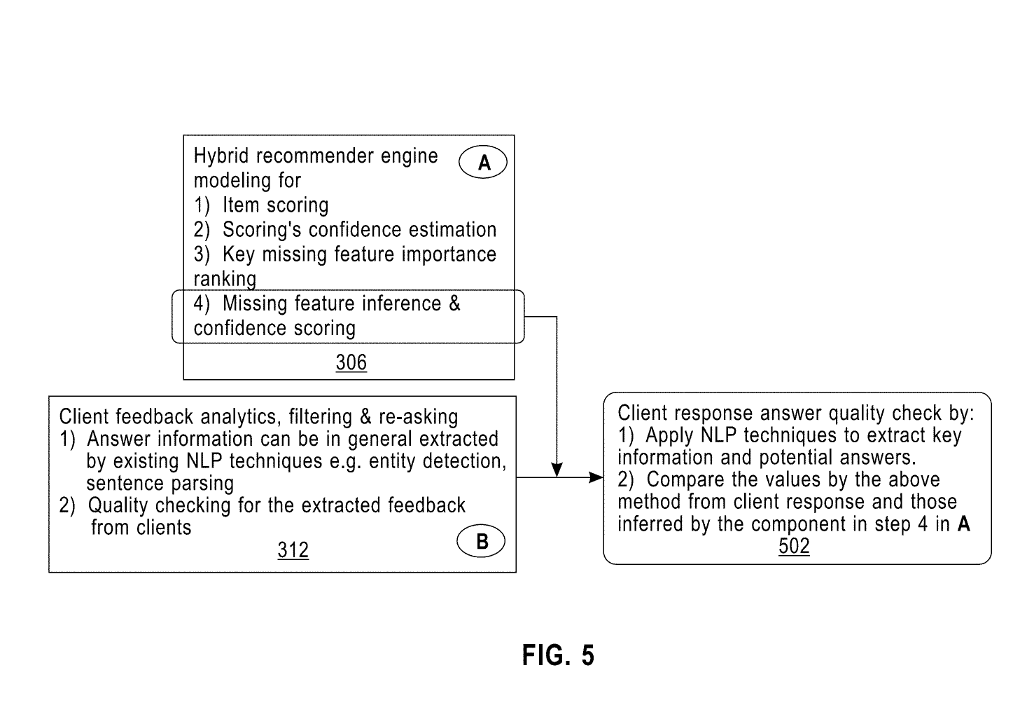

FIG. 5 is a block diagram of an embodiment of a client feedback analytics, filtering, and re-asking unit 312 in accordance with the present invention.

The hybrid recommender engine 306 includes a missing feature inference and confidence scoring module. The client feedback analytics, filtering and re-asking unit 312 output and the output of the hybrid recommender engine 306 related to the missing feature inference and confidence scoring are provided as input to a client response answer quality check 502.

The client response answer quality check 502 applies NLP techniques to extract key information and potential answers and compares the values by applying the NLP method from client response with those inferred by the missing feature inference and confidence scoring component in the hybrid recommender engine.

For hybrid recommender engine 306, item scoring and scoring confidence estimation, regression based methods that combine the profile and purchase data are applied to estimate the preference for each item and their confidence level. Likewise, hybrid recommender engine 306 key missing feature importance ranking feature importance can be computed by a regression model.

For hybrid recommender engine 306 missing feature inference and confidence scoring and client feedback analytics 312, quality checking for the extracted feedback from clients, K-NN is performed to find the given client's most similar clients, and use their feature values to perform quality check by comparing the consistency between the prediction of the K-NN model based on existing information and the extracted value from the answers which may contain noise due to the client's response and the NLP techniques. The quality check is performed by computing the distance between the inferred feature value and the parse feature value from the client's answer. The confidence level can be computed based on the diversity and variance of other similar clients' feature values.

When the collected features go through the quality check step, they will be used as input together with existing features to update the hybrid recommender engine and the loop continues.

An example of regression for the hybrid recommender engine (scoring) 306 may use for its input features client profile, such as industry, revenue, profit, IT investment and dynamic purchase data: total purchase revenue regarding with different items. The output values may be purchase distribution of items.

Feature importance scoring can be done offline by removing some designated features and monitor performance response. Feature confidence scoring, K-NN can be used to estimate the missing feature (mx) by looking at the K Nearest Neighbors (other clients) with this feature value (x1, x2, x3, . . . xN):

mx=(x1+x2+ . . . +xN)N for numerical features, and
mx=the most frequent value in (x1, x2, x3, xN) for categorical features.

The similarity can be computed by using both client profile and purchase data using the Euclidean distance dx between two feature vectors: dx=∥x1−x2∥, where x1, x2 are feature vectors.

FIG. 6 is a schematic diagram of an embodiment of a client question tuning and customization 600 in accordance with the present invention.

The output of the question style analyzer engine 310 is provided to a switch 602, the output from which is provided to a client (user) 604. The switch determines the form of the questions, such as “why”, “how”, “what”, and “is” formats. Dynamic ranking is achieved by the preference of the question style based on the client feedback regarding the answer quality and analysis of the client's feeling of the question. The purpose of generating different forms of questions is to improve the diversity of question categories and to improve the natural language of the conversation.

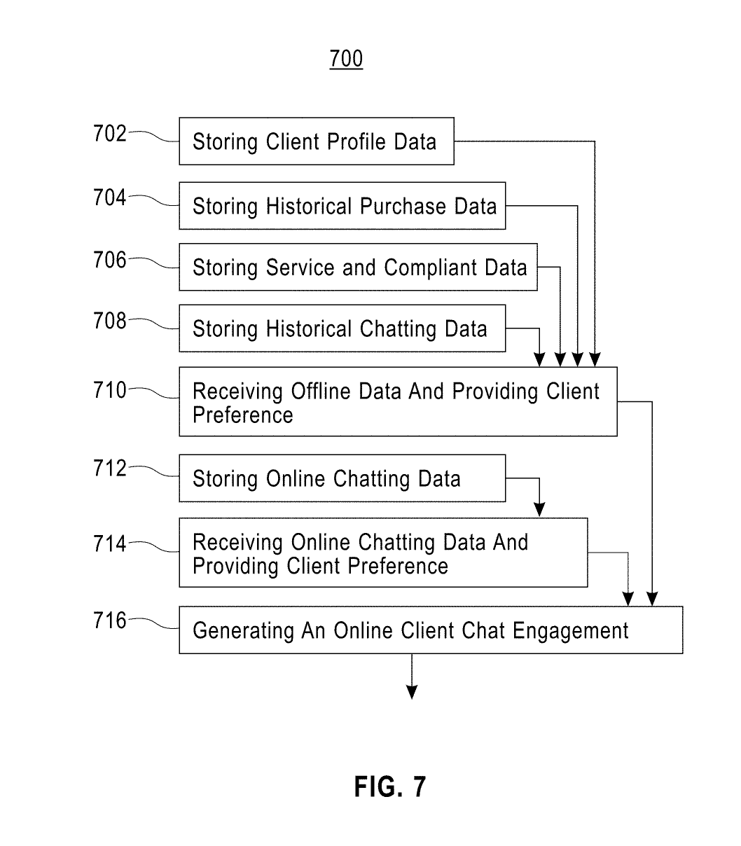

FIG. 7 is an embodiment of a method in accordance with the present invention.

Initially, clients information are stored by storing client profile data in step 702, storing historical purchase data in step 704, storing service and complaint data in step 706, and storing historical chatting data in step 708. The data stored in steps 702-708 can be provided offline for determining client preferences based on the received data in step 710.

There is real-time storing of online chatting data in step 712. The online chatting data can be provided online for determining client preferences based on the online chatting data in step 714.

The client preference resulting from the offline data from step 710 and the client preference resulting from the online data in step 714 are fused or combined for generating an online client chat engagement in step 716.

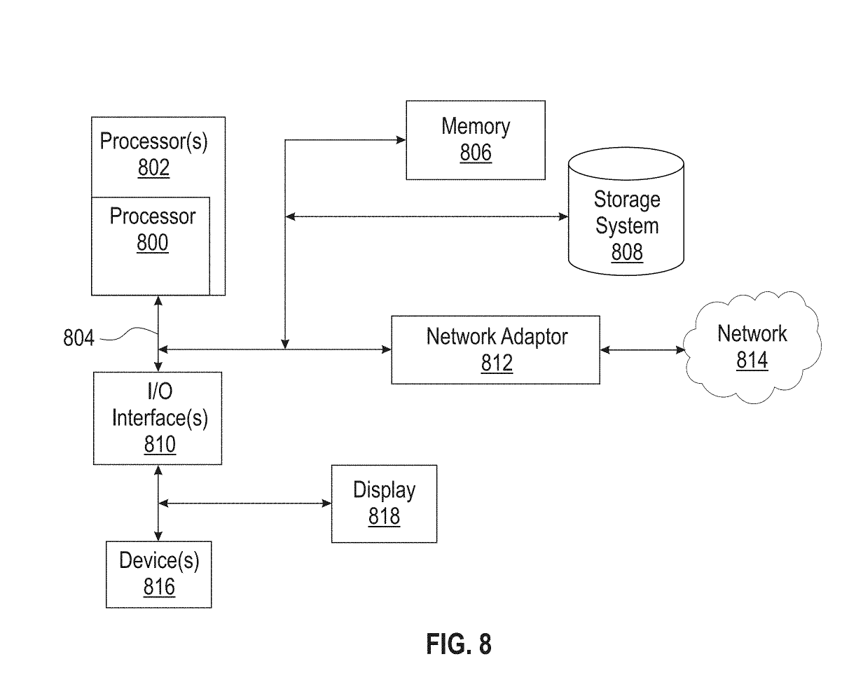

FIG. 8 is an embodiment of a computer or processing system in accordance with the present invention.

The computer or processing system shown may recommend integrated online digital sales service chat system which can be applied for automatic or semi-automatic online client chat engagement, in one embodiment of the present disclosure. The computer system illustrated is one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 8 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 802, a system memory 806, and a bus 804 that couples various system components including system memory 806 to processor 802. The processor 802 may include a module 800 that performs the methods described herein. The module 800 may be programmed into the integrated circuits of the processor 802, or loaded from memory 806, storage device 808, or network 814 or combinations thereof.

Bus 804 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 806 can include computer system readable media in the form of volatile memory, such as random access memory (RAM) and/or cache memory or others. Computer system may further include other removable/non-removable, volatile/non-volatile computer system storage media. By way of example only, storage system 808 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 804 by one or more data media interfaces.

Computer system may also communicate with one or more external devices 816 such as a keyboard, a pointing device, a display 818, etc.; one or more devices that enable a user to interact with computer system; and/or any devices (e.g., network card, modem, etc.) that enable computer system to communicate with one or more other computing devices. Such communication can occur via Input/Output (I/O) interfaces 810.

Still yet, computer system can communicate with one or more networks 814 such as a local area network (LAN), a general wide area network (WAN), and/or a public network (e.g., the Internet) via network adapter 812. As depicted, network adapter 812 communicates with the other components of computer system via bus 804. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in reverse order, depending upon the functionality involved. It will also be noted that each block of the block diagrams and/or flowchart illustration, and combinations of blocks in the block diagram and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A recommendation driven online digital sales chat service system comprising:
a processor;
a memory, operably coupled to the processor, and storing:
client profile data; historical purchase data; service and complaint data offline; and
historical chat data; language corpus and materials and online chat data online;
an offline client preference inference engine configured to receive the offline client profile data, the historical purchase data, the service and complaint data;
an online client interest inference engine configured to receive the online historical chat data; language corpus and materials and online chat data and to generate an online client preference based on the online chat data;
an online client preference fusion and detection and client valuation module configured to generate an online client chat engagement based on the offline client preference and the online client preference.

2. The system of claim 1, wherein the online client chat engagement generated includes information selected from a group consisting of: cross-selling; up-selling; promotion;
active client information collection; and low-value client identification.

3. The system of claim 1, further comprising:
a hybrid recommender engine, including at least one scoring module selected from a group consisting of: a scoring confidence estimation module; a key missing client profile feature importance scoring module; and a missing feature inference and confidence scoring module; and
a client feedback analytics, filtering and re-asking module configured to extract client feedback by natural language processing (NLP) techniques, perform quality checking for extracted feedback from clients, and dynamically revise one or more of style and content of a client question based on client sentiment on the feedback.

4. The system of claim 3, wherein the missing feature inference and confidence scoring module determines a missing feature using K-nearest neighbors algorithm

5. The system of claim 3, wherein confidence score is calculated by extracting key information and potential answers and comparing values from the chat response with those inferred by the missing feature inference.

6. The system of claim 1, wherein quality checking is performed repeatedly changing the question style responsive to a confidence level based on response to the question until the confidence level reaches a predetermined level.

7. The system of claim 1, wherein the online inference engine uses a hybrid regression model together with collaborative filtering (CF) filtering.

8. (canceled)

9. (canceled)

10. (canceled)

11. (canceled)

12. (canceled)

13. (canceled)

14. (canceled)

15. A computer program product:
storing client profile data;
storing historical purchase data;
storing service and complaint data;
storing historical chatting data;
receiving offline client profile data, historical purchase data, service and complaint data, and historical chatting data and providing an output;
storing online chatting data;
receiving online chatting data and providing an output; and
receiving the outputs based on the offline data and based on the online data for generating an online client chat engagement.

16. The computer program product of claim 15, wherein the online client chat engagement includes information selected from the group consisting of: cross-selling, up-selling, promotion, active client information collection, and low-value client identification.

17. The computer program product of claim 15, further comprising:
scoring item and scoring confidence estimation for making a recommendation;
scoring key missing client profile feature importance for selective re-asking a question, and scoring missing feature inference and confidence for evaluating client's feedback after re-asking a question;
extracting answer information by NLP techniques;
checking quality for extracted feedback from clients; and
revising client question and customizing by analyzing client's quality of the feedback to dynamically update question style and content.

18. The computer program product of claim 17, wherein scoring the missing feature importance and confidence determines a missing key feature using K-nearest neighbors algorithm

19. The computer program product of claim 17, wherein confidence scoring is calculated by extracting key information and potential answers and comparing values from the feedback response with those inferred by the missing feature.

20. The computer program product of claim 15, wherein quality checking is performed repeatedly changing the question responsive to a confidence level based on response to the question until the confidence level reaches a predetermined level.
